(19) United States
(12) Patent Application Publication
(10) Pub. No.: US 2013/0037475 A1
(43) Pub. Date: Feb. 14, 2013

(54) Filtration Device

(71) Applicants: Heiko Freter, Einbeck (DE); Klaus Mosges, Holzminden (DE); Stephan Fritsch, Paderborn (DE)

(72) Inventors: Heiko Freter, Einbeck (DE); Klaus Mosges, Holzminden (DE); Stephan Fritsch, Paderborn (DE)

(73) Assignee: A. KAYSER AUTOMOTIVE SYSTEMS GMBH, Einbeck (DE)

(21) Appl. No.: 13/639,932

(22) PCT Filed: Mar. 31, 2011
(86) PCT No.: PCT/EP2011/001626

§ 371 Date: Oct. 8, 2012

(30) Foreign Application Priority Data
May 7, 2010 (DE) 10 2010 019 871.4

(51) Int. Cl. B01D 33/23; B01D 33/37; B01D 33/70

(52) U.S. Cl. 210/232

(57) ABSTRACT

A filtration device consists of a rotor system (2) which is mounted so that it can be driven to rotate about a horizontal axis (5) in a basin (1) containing a liquid bath, said rotor system consisting of three arrangements (15), for example, each comprising a filter disk pushed onto the tubular cylinder (17) parallel to the axis (5) and therefore being eccentric. The tubular cylinders (17) are fixedly connected to a hollow shaft (18) extending in the direction of the axis (5) for supporting the rotor system (2), this hollow shaft being supported on both ends in bearing units (6, 7) designed as friction bearings which permit a three-dimensional equalization of angle deviations of the axis of the hollow shaft (18). Each filter disk is assembled from segments made of plastic and produced in one piece with coupling pieces as molded parts formed by the injection molding process, so that the axially aligned segments of the filter disks in the state in which they have been placed on the tube cylinders (17) form a continuous filtrate collecting line (23). This yields a design of the rotor system (2) which is structurally simple and permits inexpensive production.

The invention relates to a filtration device according to the preamble of Claim 1.

Such filtration devices are used in purifying liquids, in particular wastewater, that carry an insoluble dirt load, with the goal of obtaining a reusable filtrate. However such equipment may also be used in general for separating a solid-liquid mixture into a solid phase and a liquid phase.

These devices are known in the form of rotating suction filters, for example, wherein a rotor system functioning as the carrier of disk-shaped filter elements to which a vacuum is applied on the inside is mounted so that it can be driven to rotate about a horizontal axle inside a liquid bath.

The document DE 10 2004 063 879 A1 describes one such filtration device, in which a rotor system is mounted to rotate about a horizontal axle in a liquid bath and is in a drive connection to an electric motor to be driven about this axle. The rotor system consists of a carrying disk on which are supported multiple arrangements of disk-shaped filter elements kept in stacks side by side, each enclosing a cavity, such that the cavities of each of the multiple arrangements are combined via collecting lines connected on the outside radially, and the collecting lines of all arrangements are brought together centrally. The arrangements include a space extending coaxially with the axle of the carrying disk, such that a lance intended for carrying purging air protrudes into said space. Another lance that can be activated in case of need and is also intended for carrying purging air is located on the bottom side beneath the rotor system. The filter elements consist of segments representing the shape of a circular disk in the assembled state, and these segments are held individually on continuous rod-like carriers that are connected to the carrying disk with spacers interspersed between segments. This means that assembly and dismantling of the filter disks and/or the segments is/are comparatively complex because of the individual mounting of the filter segments. A substantial effort is also to be seen in combining the filtrate of the individual filter elements.

The document DE 26 51 151 A1 discloses another rotating suction filter in which a rotor system that can be driven to rotate about a horizontal axle is provided in a tank. This rotor system consists of a centrally arranged shaft provided with axially parallel longitudinal channels that are in turn connected to a vacuum source, such that each longitudinal channel is connected in a through connection through radial openings to a filter segment. These openings are arranged axially in groups with an axial distance from one another, with the provision that the filter segments connected to the openings shall form a plurality of structures in the shape of filter disks spaced a distance apart from one another along the shaft. For connecting the filter segments to the openings, special connecting elements that are bolted to the shaft are provided.

One disadvantage of this embodiment is a comparatively complicated design because a specially designed shaft equipped with special connecting elements and having longitudinal channels is required, and this shaft is assembled with filter segments that are to be installed and dismantled individually.

One disadvantage of this state of the art is a relatively large design complexity for producing a rotor system that carries filter disks.

The object of the present invention is to provide a filtration device of the generic type identified above with regard to a simpler structural design, in particular also to improve the handling in assembly of segmented filter disks. This object is achieved with such a filtration device through the features of the characterizing part of Claim 1.

It is thus essential to the invention that the segments of each filter disk are interconnected, so that a load-bearing structure is obtained without any additional measures. The filter disk produced in this way is accessible to standardized handling; in other words, it can be installed as a unit and dismantled as a unit. The segments of the filter disk may be joined together in a form-fitting manner, for example, in the circumferential area, and may additionally be bolted or riveted. Any joining techniques with which those skilled in the art are familiar may be used at this point.

It is also essential to the invention that the filter disks designed in this way can be attached to a central tubular carrier as part of an arrangement. The cohesion of an arrangement formed by a package of filter disks is thus achieved exclusively by this carrier, so that in departure from the prior art presented initially, each individual segment need not be connected individually to certain supporting structures of a rotor system for assembly.

On the whole, this yields a rotor system characterized by a comparatively simple design.

The features of Claims 2 and 3 are directed at details of the design of the filter disks which in any case enclose a cavity wherein the cavities of all filter disks of an arrangement are equipped with interconnectable coupling pieces which form a continuous filtrate-collecting line in the assembled state. The segments are preferably made of plastic and can be produced inexpensively as moldings in one piece with the aforementioned coupling pieces by the injection molding process. A filtrate-collecting line produced in this way connects all the segments axially aligned with one another in one arrangement.

The features of Claims 4 to 6 are directed at different rotor systems, which differ with regard to the number of arrangements installed. For the case when the rotor system comprises two or more arrangements, the carrier of an arrangement to which the filter disks can be attached is formed by a tubular cylinder that is parallel to the axle of the rotor system but is also eccentric with it. The tubular cylinder is fixedly connected to a hollow shaft, about the axle of which the rotor system can be driven to rotate. If the rotor system has only one arrangement, then the carrier mentioned above is formed directly by its hollow shaft.

According to the features of Claims 7 and 8, the filter disks of an arrangement are clamped in their installed position, so they yield elastically axially between two supporting structures, one of which is arranged to be movable against the force of a spring element. Positioning of the package comprised of filter disks on the aforementioned carrier which allows axial equalizing movements free of play between the package consisting of the filter disks and the hollow shaft can thus be displayed in this way.

The features of Claims 9 and 10 are directed at securing the filter disks of an arrangement with respect to one another. To prevent stress states which could occur because of material-related differences in the in thermal expansion properties of the filter disks, which are preferably made of plastic, on the one hand, and the connecting elements, which are usually metallic, e.g., threaded bolts, on the other hand, it is proposed according to the features of Claims 9 and 10 that only subsets consisting of, for example, two filter disks following one another directly in succession axially may be attached to one another peripherally and centrally by means of the connecting elements, so that long, continuous connecting elements need not be used in any case. In addition, the connecting elements of subsets of the filter disks following one another in the axial direction may be arranged so they are offset in the peripheral direction. The effects of a material-specific difference in thermal expansion properties can be kept within limits by these means.

The features of Claims 11 and 12 are directed at the spatial arrangement of the distributor lances intended for introduction of fluid to be filtered into the liquid bath. These lances are located in a central area of the rotor system, adjacent to its axle and extend over its entire length. They may also be arranged in a central area of an arrangement, adjacent to its axle, running parallel to its axle, extending over its entire length and passing through recesses in the filter disks.

The features of Claims 13 and 14 are directed at the design of the bearing of the rotor system. Friction bearings which permit a three-dimensional equalization of angular deviations of the hollow shaft accommodated therein and supporting the rotor system. Stresses in the frame which could otherwise occur due to these deviations are prevented as a result of this measure.

This prevents penetration of foreign substances from the liquid bath, in particular abrasive substances, into the bearings due to the fact that the bearings, in particular their friction surfaces, are acted upon by a sealing fluid which is always subject to a flow out of the bearings an into the liquid bath.

According to the features of Claims 15 and 16, load-bearing structural elements of the rotor system are used as a media line, in this case for the filtrate line. This makes it possible to eliminate a complex and susceptible tubing system that would otherwise be necessary. Essentially hollow sections are suitable for this purpose.

According to the features of Claim 17, the characteristics are similar for the supply of compressed air of a line network situated on the bottom inside the liquid bath. Compressed air may thus be supplied through elements of a frame supporting the network.

The invention is described in greater detail below with reference to the exemplary embodiment depicted in the drawings, in which:

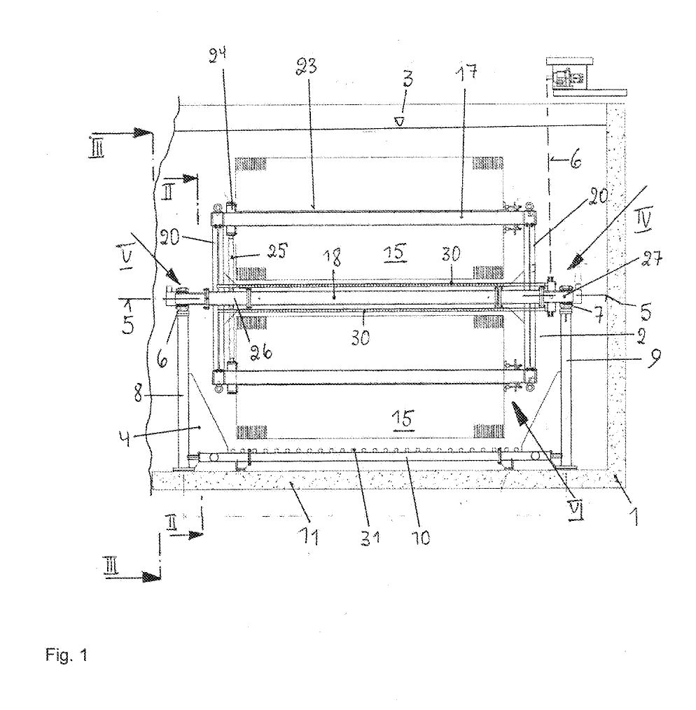

FIG. 1 shows a partial view of a filtration device according to the invention in a vertical sectional plane;

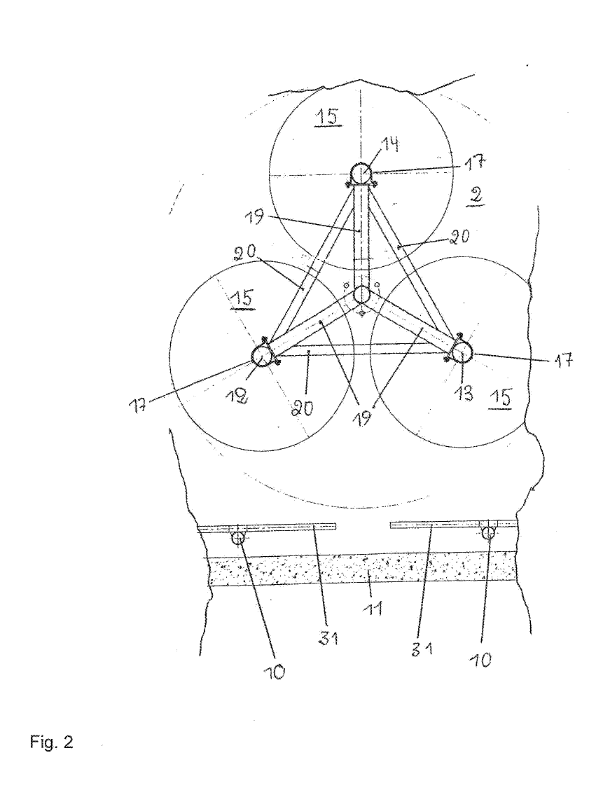

FIG. 2 shows a partial view of the filtration device shown in FIG. 1 in a sectional plane II-II;

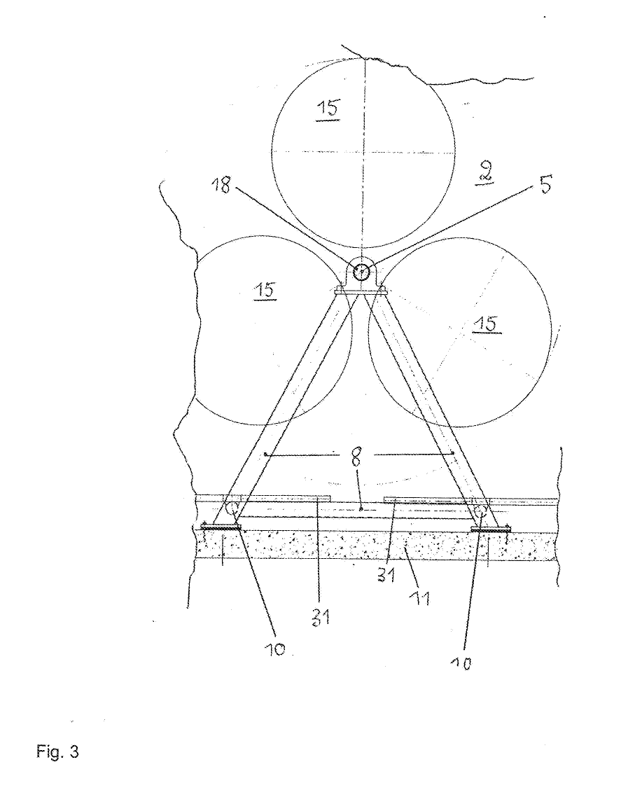

FIG. 3 shows a partial view of the filtration device shown in FIG. 1 in a sectional plane III-III;

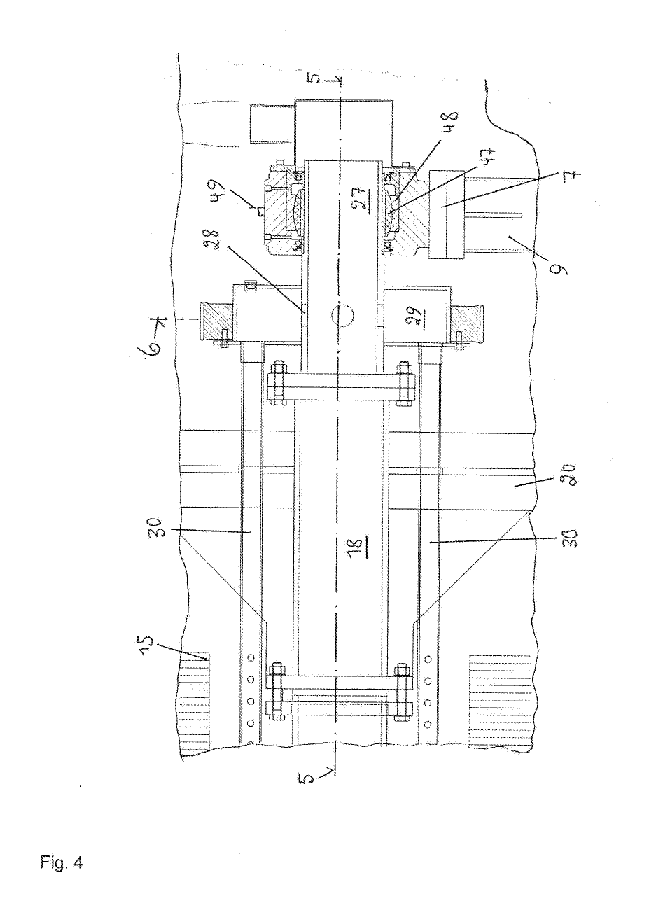

FIG. 4 shows an enlarged partial diagram of a detail IV from FIG. 1;

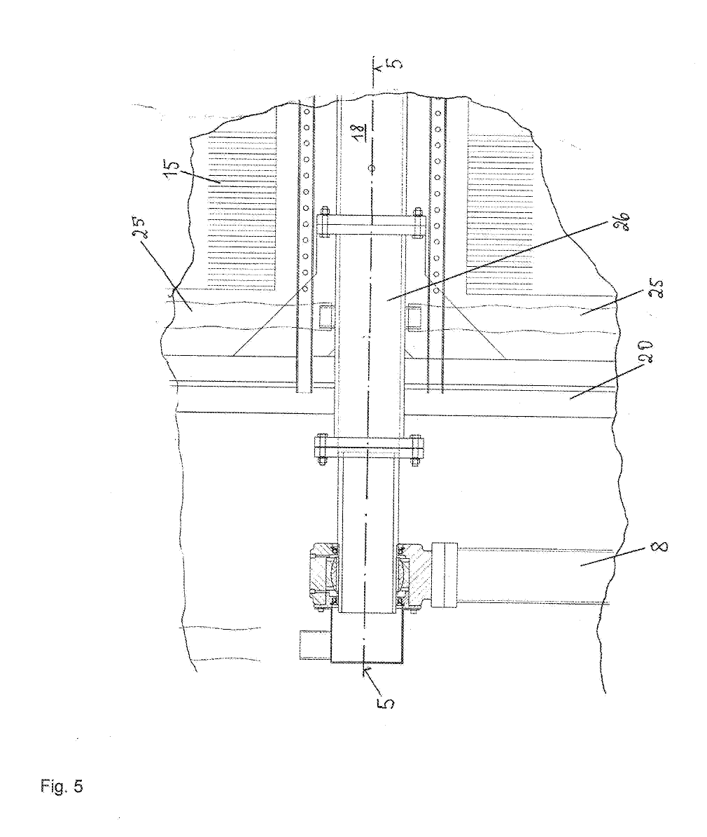

FIG. 5 an enlarged partial diagram of a detail V from FIG. 1;

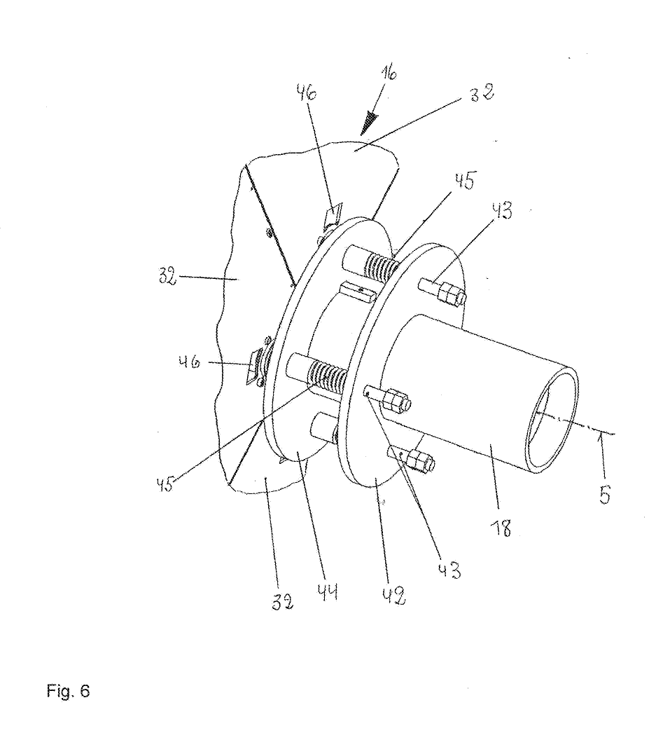

FIG. 6 shows a partial perspective view of a detail VI from FIG. 1 on an enlarged scale;

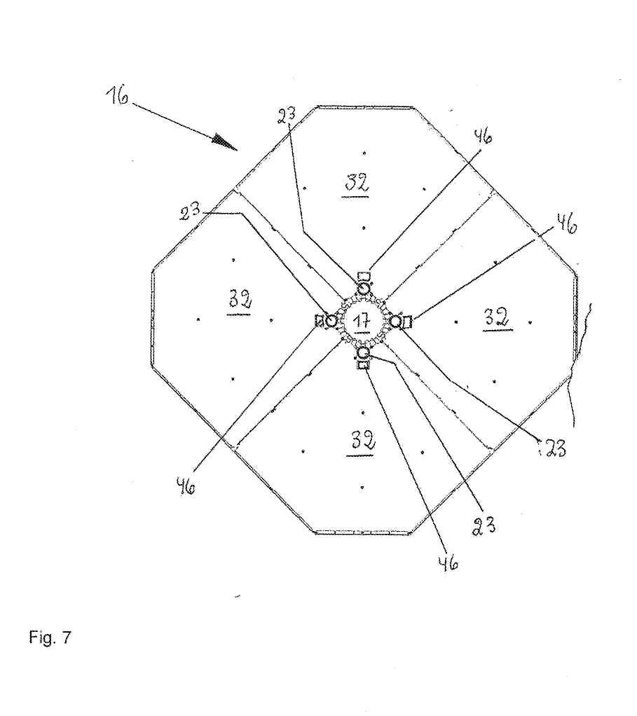

FIG. 7 shows an isolated diagram of a filter disk in a view from above;

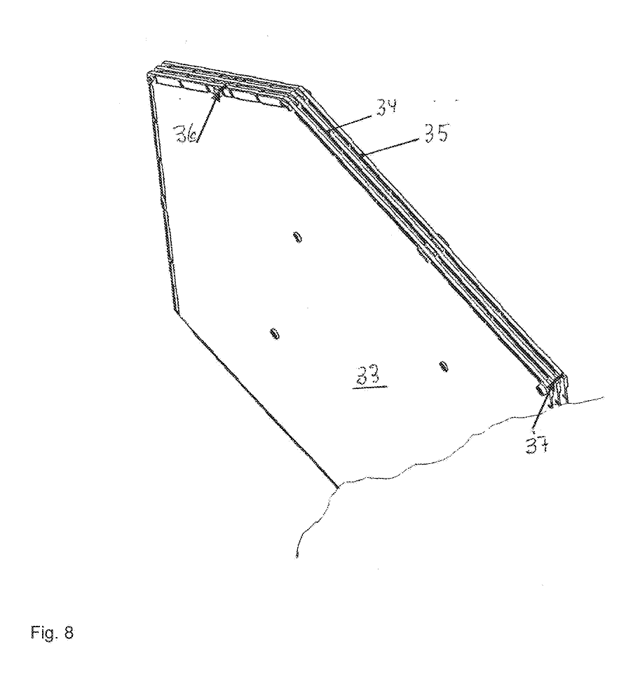

FIG. 8 shows a schematic perspective diagram of the edge mounting of the segments of three successive filter disks;

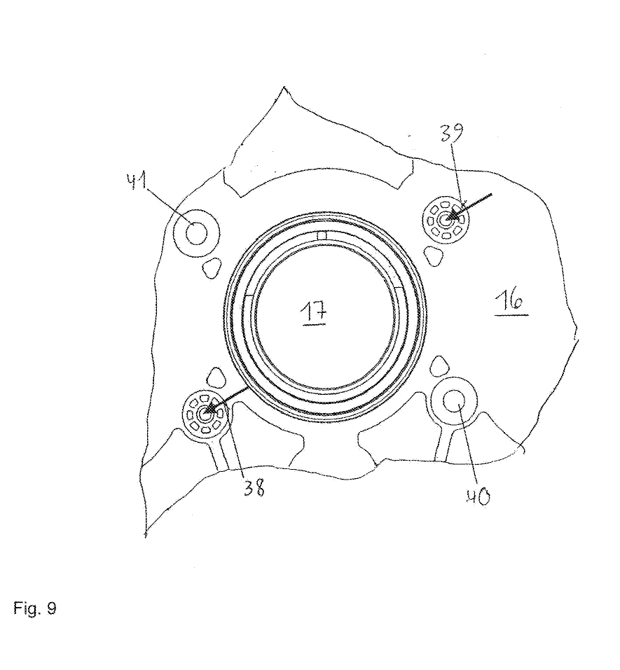

FIG. 9 shows a simplified partial planar diagram of the central mounting of the segments of successive filter disks;

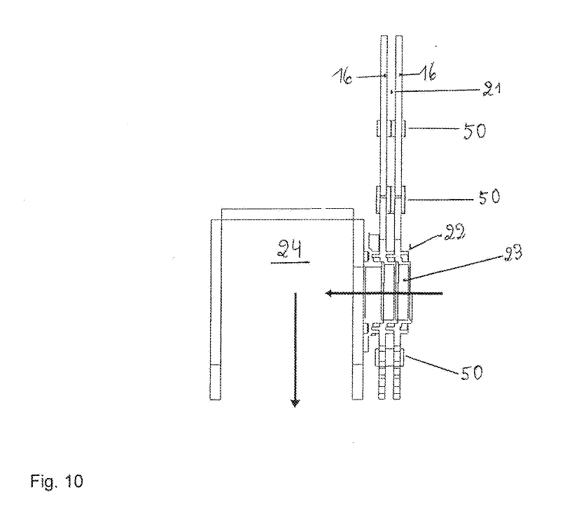

FIG. 10 shows an enlarged partial sectional diagram of the end area of a rotor system according to the invention.

The filtration device shown in FIG. 1 consists of a basin 1, which is open at the top to receive the liquid to be filtered, and a rotor system 2 to be described below, which is permanently mounted inside the basin at the bottom. The rotor system 2 is below the liquid level 3 inside the basin 1 during operation of the device.

In all the figures of the drawings, the same or corresponding function elements are all labeled with the same reference numerals.

The rotor system 2 is mounted on the bottom to rotate about a horizontal axle 5 in a frame 4 erected in the basin 1 and is in a driving connection with an electric motor that is arranged above the basin 1 but is not shown in the drawing, this connection being by way of a traction gear 6, e.g., a toothed bolt gear. The frame 4 consists of three bearing supports 8, 9 which form a triangular supporting structure and are interconnected via longitudinal struts 10 extending on the bottom side, such that these three bearing supports each hold two bearing units 6, 7, designed to be essentially the same, on the face ends of the rotor system 2. The bearing supports 8, 9 are secured on the bottom 11 of the basin 1 in a suitable manner and may be attached to it by bolts, for example. The bearing units 6, 7 are advantageously designed so that simple removal of the rotor system as a standard module from the basin 1 and renewed insertion into the basin 1 can be performed easily. This simplifies maintenance work on the rotor system 2.

As can be seen on the basis of FIGS. 4 and 5, each of the two bearing units 6, 7 is characterized by a bearing body 47, which is in the form of a spherical shell and is accommodated in a bearing seat 48 having a corresponding spherical shell shape. Three-dimensional equalizing movements are made possible in this way, even if the assembly is skewed, and when vibrations occur due to dynamic loads, thus permitting a stress-free condition of the rack 4.

A connection 49 is provided for each of the two bearing units 6, 7, intended for introducing a sealing fluid between the surfaces of the bearing seat 48 and of the bearing body 47 which are slidable in relation to one another. Penetration of foreign substances into the space between the aforementioned surfaces and the associated wear are reliably prevented by the pressurized solids-free sealing fluid. The fluid used as a sealing fluid may be the filtrate obtained through the filtration process, for example.

The rotor system 2 consists of, for example, three arrangements 15 each held on axles 12, 13, 14 extending in parallel to one another and to the axle 5 and consisting of individual filter disks 16. Each of these arrangements 15 in turn consists of a central tubular cylinder 17 extending coaxially with the respective axle 12, 13, 14, such that these tubular cylinders 17 are supported at the end by means of a star-shaped arrangement of tubular cylinders 19, which form a load-bearing frame on a central hollow shaft 18 that carries the rotor system 2 and is mounted to rotate about the axle 5, while at the same time these tubular cylinders function as collecting lines for the filtrate produced. Nodular struts 20 arranged in a triangular shape at the ends of the rotor system 2 provide stabilization.

The arrangements 15 are preferably held in the rotor system 2 in such a way that a simple dismantling or installation as a module is possible if needed.

The filter disks 16 are tightly stacked, leaving comparatively narrow interspaces 21 on the tubular cylinder 12 forming a supporting structure and are interconnected via coupling pieces 21, which can be inserted tightly into one another and in the assembled state form a line section arranged in an area near the axle such that the totality of these coupling pieces 22 forms a filtrate-collecting line 23. The interspaces may be designed to be of the dimension of 8 mm for example.

Each filter disk 16 is assembled from four disk-shaped segments 32, each preferably made of a plastic, which are interconnected in the circumferential area for example by being riveted to one another. However, other joining methods with which those skilled in the art are familiar may equally be taken into account. In the assembled state, the segments 32 form a uniformly handleable filter disk 16, pentagonally shaped in this case and provided with a central opening so that they can be stacked on the tubular cylinder 17.

Each of the segments 32 is provided with at least one coupling piece 22 as shown in FIG. 9 so that segments 32 arranged axially in succession on the tubular cylinder 17 at least form a filtrate-collecting line 23.

A segment 32 may consist of a molding produced by the injection molding process in the form of a frame or a mesh, its flat top and bottom sides being covered with a filter cloth or a membrane. In any case this yields a cavity which is bordered by a filter cloth and is set up over the filtrate-collecting line for discharging filtrate.

In the example shown here for filtrate-collecting lines 23 are provided according to the four segments 32.

The filter disks 16 of each of the three arrangements 15 are interconnected, namely at the sides as shown in FIG. 7 on the example of the connection between three segments 33, 34, 35 following one another axially within one arrangement.

A metallic connecting element, e.g., a threaded bolt, a rivet or the like connects only the first segment 33 to the second segment 34 at the site 36 but not to the third segment 35. At the location 37 however a connection is established between the second segment 34 and the third segment 35 in the same way but not with the first segment 33. Since continuous connecting elements, i.e., those that pass through all the axially successive segments and secure them uniformly in relation to one another, are omitted, any influence of thermally induced different expansions of the aforementioned metallic connecting elements on the one hand and the filter disk 16 made of plastic on the other hand is kept within narrow limits, in particular within tolerable limits.

The filter disks 16 of an arrangement 15 as shown in FIG. 8 are connected centrally, i.e., in an area adjacent to the tubular cylinder 17 such that connecting elements by means of which two filter disks 16 opposite one another axially on the tubular cylinder 17 are used in diametrically opposite positions 38, 39. However, the boreholes, which are at the positions 40, 41 arranged with a 90° offset in the circumferential direction in comparison with the positions 38, 39 and are aligned therewith in the adjacent filter disk, are intended to receive connecting elements by means of which the second and third filter disks which are axially adjacent to the filter disks 16 shown here are interconnected. Due to the fact that the connecting elements are used with the provision that their fastening effect includes only two filter disks and/or segments axially adjacent to one another, a constraint-free state of the filter disk package of an arrangement 15 is made possible even at elevated temperatures and/or varying temperatures.

Otherwise there are only spacers 50 between the filter disks 16 of an arrangement 15, so that a simple mechanically stable design of an arrangement 15 which meets all operational requirements is obtained by the combination of these spacers with the connecting elements mentioned above.

The package of filter disks 16 resting on the filtrate receptacle chamber 24 pushed onto the hollow shaft 18, as shown at the left in FIG. 1, is supported on the right side with axial spring support as shown in an enlarged diagram in FIG. 5.

For this purpose, a flange ring 42 can be secured axially on the hollow shaft 18, namely on the right end in FIG. 1, such that a plurality of uniformly distributed threaded bolts 43 on the periphery and running parallel to the axle 5 secure a ring flange 44 which is in contact with the package consisting of the filter disks 16 on its one side, on the hollow shaft 18 on which it is slidably arranged. It can be seen here that the aforementioned package is elastically clamped between the fixedly arranged filtrate receptacle chamber 24 and the ring flange 44.

The entirety of all filtrate collecting lines 23 of each arrangement 17 is continuously connected to a filtrate receptacle chamber 24 such that all these filtrate receptacle chambers 24 are in turn combined by means of connecting pieces 25, and the tubular cylinders 19 are combined in a collecting chamber 26 formed by a section of the hollow shaft 18. The filtrate can be discharged from this collecting chamber 26 through a line (not shown in the drawing).

The liquid that is loaded with contaminants and is to be filtered passes through a line (not shown in the drawing) first into an input chamber 27 which is fixedly connected to the hollow shaft 18 and then out of this chamber through peripheral openings 28 into a first distributing chamber 29 which surrounds the openings like a ring and forms a part of the tension means gear 6 on the outside.

A row of distributor lances 30 are provided outside of the hollow shaft 18, extending over the entire axial length of the rotor system 2, connected to the distributor chamber 29 on the outside, namely preferably arranged uniformly in the circumferential direction and running parallel to the axle 5. These distributor lances 30 are provided with boreholes on the circumference intended for introducing the liquid to be filtered into the basin 1 from these boreholes.

Additional distributor lances may be provided for the tubular cylinders 17 of the individual arrangements 15 which are also connected to the distributor chamber 29 in a manner not shown in the drawing. For this purpose, these segments 32 are provided with aligned recesses 46 in which these distributor lances can be secured, as shown in FIGS. 6 and 7.

The distributor lances assigned to the tubular cylinders 17 on the one hand and the distributor lances 30 assigned to the hollow shaft 18 on the other hand may also be acted upon by the liquid to be filtered as an alternative with an intermediate arrangement of cutoff elements with which those skilled in the art are familiar.

A network 31 of pipelines arranged on the bottom inside the basin 1 beneath the rotor system 2 can be supported on the longitudinal struts 10, for example, and can serve to introduce compressed air into the liquid bath inside the basin 1 through uniformly distributed boreholes. The network 31 and the aforementioned boreholes are created with the provision that within the interspaces 21 between the filter disks 16, there is an area in which air bubble ascend in a uniform distribution, creating an upward flow field and exerting a cleaning effect on the filter surfaces of the filter disks directed at removal of deposits.

In practical terms, the pipelines of the network 31 may be made of perforated supporting tubes, each of which is covered with a perforated tubular membrane inverted over it, said membrane consisting of an elastomer material, for example. When the compressed air is introduced, a pressure-dependent expansion of the membrane occurs and associated with this air bubbles escape into the liquid bath.

During operation, dirty water, e.g., wastewater carrying a burden of solids, is introduced into the input chamber 27 of the filtration device. Then the dirty water goes through the distributor chamber 29 and the distributor lances 30 into the+liquid bath of the basin 1. In the basin 1, the rotor system 2 rotates about the axle 5, such that the movement of the bath due to the air bubbles ascending out of the network 31 induced by this rotational movement is superimposed on an upwardly directed flow.

List of reference numerals

| | |
|---|---|
| 1. | basin |
| 2. | rotor system |
| 3. | liquid level |
| 4. | frame |
| 5. | axle |
| 6. | bearing unit |
| 7. | bearing unit |
| 8. | bearing support |
| 9. | bearing support |
| 10. | longitudinal strut |
| 11. | bottom |
| 12. | axle |
| 13. | axle |
| 14. | axle |
| 15. | arrangement |
| 16. | filter disk |
| 17. | tubular cylinder |
| 18. | hollow shaft |
| 19. | tubular cylinder |
| 20. | nodular strut |
| 21. | intermediate space |
| 22. | coupling piece |
| 23. | filtrate collecting line |
| 24. | filtrate receptacle |
| | chamber |
| 25. | connecting piece |
| 26. | collecting chamber |
| 27. | input chamber |
| 28. | opening |
| 29. | distribution chamber |
| 30. | distributor lance |
| 31. | network |
| 32. | segment |
| 33. | segment |
| 34. | segment |
| 35. | segment |
| 36. | location |
| 37. | location |
| 38. | location |
| 39. | location |
| 40. | location |
| 41. | location |
| 42. | flange ring |
| 43. | threaded bolt |
| 44. | ring flange |
| 45. | spring element |
| 46. | recess |
| 47. | bearing body |
| 48. | bearing seat |
| 49. | connection |
| 50. | spacer |

1-17. (canceled)

18. A filtration device having a rotor system (2) which can be driven to rotate about a horizontal axis (5) in a bath formed by the liquid to be filtered, supporting at least one arrangement (15) of filter disks (16) arranged side by side, as well as having lines for supplying the liquid to be filtered and for discharging the filtrate, wherein each filter disk (16) is assembled from flat segments (32), wherein the segments (32) of each filter disk (16) are interconnected to present a portable, uniformly handleable structure and the filter disks (16) of each arrangement (15) can be attached to a central tubular support, characterized in that segments (32) positioned so they are aligned with one another in the axial direction of the filter disks (16) form a continuous filtrate collecting line (23) via integrally molded coupling pieces (22), and the coupling pieces (22) of axially adjacent filter disks (16) of one arrangement (15) can be attached to one another.

19. The filtration device according to claim 18, characterized in that the filter disks (16) are secured on said carrier axially under an elastic prestress.

20. The filtration device according to claim 19, characterized by a supporting structure which is axially movable against the force of the at least one spring element (45) and is fixedly connected to the carrier such that the filter disks (16) of each arrangement (15) are clamped axially between these supporting structures.

21. The filtration device according to claim 18, characterized in that (n) filter disks (16) following one another directly in the axial direction are interconnected via connecting elements arranged centrally and/or peripherally in the frame of the (N) filter disks (16) of an arrangement (15), where it holds that (n)<(N).

22. The filtration device according to claim 21, characterized in that the centrally and/or peripherally arranged connecting elements of (n) axially successive filter disks (16) are arranged so they are offset in relation to one another in the peripheral direction.

23. The filtration device according to claim 18, characterized in that each filtrate collecting line (23) is connected to a collecting chamber (26) that is used for discharge of the filtrate, the connection being by means of load-bearing structural elements of the rotor system (2) in a continuous connection.

24. The filtration device according to claim 23, characterized in that the collecting chamber (26) consists of a section of the hollow shaft (18).

25. The filtration device according claim 19, characterized in that (n) filter disks (16) following one another directly in the axial direction are interconnected via connecting elements arranged centrally and/or peripherally in the frame of the (N) filter disks (16) of an arrangement (15), where it holds that (n)<(N).

26. The filtration device according to claim 20, characterized in that (n) filter disks (16) following one another directly in the axial direction are interconnected via connecting elements arranged centrally and/or peripherally in the frame of the (N) filter disks (16) of an arrangement (15), where it holds that (n)<(N).

27. The filtration device according to claim 25, characterized in that the centrally and/or peripherally arranged connecting elements of (n) axially successive filter disks (16) are arranged so they are offset in relation to one another in the peripheral direction.

28. The filtration device according to claim 26, characterized in that the centrally and/or peripherally arranged connecting elements of (n) axially successive filter disks (16) are arranged so they are offset in relation to one another in the peripheral direction.

29. The filtration device according to claim 19, characterized in that each filtrate collecting line (23) is connected to a collecting chamber (26) that is used for discharge of the filtrate, the connection being by means of load-bearing structural elements of the rotor system (2) in a continuous connection.

30. The filtration device according to claim 20, characterized in that each filtrate collecting line (23) is connected to a collecting chamber (26) that is used for discharge of the filtrate, the connection being by means of load-bearing structural elements of the rotor system (2) in a continuous connection.

31. The filtration device according to claim 21, characterized in that each filtrate collecting line (23) is connected to a collecting chamber (26) that is used for discharge of the filtrate, the connection being by means of load-bearing structural elements of the rotor system (2) in a continuous connection.

32. The filtration device according to claim 22, characterized in that each filtrate collecting line (23) is connected to a collecting chamber (26) that is used for discharge of the filtrate, the connection being by means of load-bearing structural elements of the rotor system (2) in a continuous connection.

33. The filtration device according to claim 29, characterized in that the collecting chamber (26) consists of a section of the hollow shaft (18).

34. The filtration device according to claim 30, characterized in that the collecting chamber (26) consists of a section of the hollow shaft (18).

35. The filtration device according to claim 31, characterized in that the collecting chamber (26) consists of a section of the hollow shaft (18).

36. The filtration device according to claim 32, characterized in that the collecting chamber (26) consists of a section of the hollow shaft (18).
